(19) United States
(12) Patent Application Publication
(10) Pub. No.: US 2009/0199532 A1
(43) Pub. Date: Aug. 13, 2009

(54) Fruit harvesting belt and bucket system

(75) Inventors: Giulia Earle-Richardson, Oneonta, NY (US); Andrew Earle-Richardson, Oneonta, NY (US); Christine Mason, Cooperstown, NY (US); Michael Rowland, Augusta, ME (US); Suzanne Stack, Cooperstown, NY (US)

Correspondence Address: PILLSBURY WINTHROP SHAW PITTMAN LLP, P.O BOX 10500, McLean, VA, 22102, US

(73) Assignee: MARY IMOGENE BASSETT HOSPITAL, Cooperstown, NY (US)

(21) Appl. No.: 12/069,634

(22) Filed: Feb. 12, 2008

(51) Int. Cl. A01D 46/22

(52) U.S. Cl. 56/328.1

(57) ABSTRACT

A fruit harvesting belt and bucket system provides for the redistribution of weight from the wearer's shoulders to the wearer's hips. The belt includes a padded back support and a front support. There is an extrusion on the front support that is used to connect to a bucket, which is strapped to a person wearing the belt. The belt is adjustable, and may be made of a variety of materials, such as nylon. The bucket may hook onto the extrusion on the belt, and the bucket has a closeable opening at the bottom, which is used to release the harvested fruit.

### FIELD OF THE INVENTION

The present invention relates generally to personal harvesting equipment, and more specifically to a weight redistribution belt system for transferring the weight of a harvesting bucket from the user's shoulders to the user's hips.

### BACKGROUND OF THE INVENTION

Some fruit harvest workers wear a picking bucket, which is situated around the wearer's shoulders with straps. As the bucket becomes filled with the harvested fruit, the bucket's weight increases. A bucket is considerably heavy when it is filled with fruit, which places excessive strain upon the wearer's shoulders, back, and neck. The fruit harvest workers repeatedly fill these buckets over the course of the day, and with each filled bucket, the strained worker is apt to suffer physical injury. During a worker's lifetime, the repeated stress can cause significant disabilities. When a worker is injured, not only is there lost time and manpower, but the worker may also suffer permanent damage that could prevent the worker from participating in any type of physical activity or trade.

### SUMMARY OF THE INVENTION

An improved weight redistribution fruit harvesting belt and bucket system is disclosed, which in one embodiment, may include an improved fruit harvesting belt which includes an extrusion along the front of the belt for support and carriage of a fruit bucket.

Another embodiment of the present invention is directed to provide an improved fruit harvesting belt which includes an adjustable strap for providing sizing capabilities.

Yet another embodiment of the present invention is directed to provide an improved fruit harvesting belt which includes a padded back support to assist with the wearer's stabilization and to provide for the wearer's comfort.

A further embodiment of the present invention is directed to provide an improved fruit harvesting belt which includes a padded front strap to assist with the wearer's comfort.

### BRIEF DESCRIPTION OF THE DRAWINGS

FIG. 1 is a plan view of a belt according to an embodiment of the present invention.

FIG. 2 is a plan view of a belt according to another embodiment of the present invention.

FIG. 3 shows the interior of a back support according to an embodiment of the present invention.

FIG. 4 is a perspective view of the exterior of a front support according to an embodiment of the present invention.

FIG. 5 shows a harvester support belt and a fruit harvesting bucket in accordance with an embodiment of the present invention.

### DETAILED DESCRIPTION

It is noted that although the following description is given in terms of an illustrative example, such as using the belt in conjunction with a bucket, the present invention can be used with a variety of buckets or receptacles to which a connector as described herein can be coupled, the connector being received by the belt.

Referring now to the drawings, the present invention will be seen to relate to a fruit harvester's support belt 10 providing for the carriage of a fruit harvesting bucket 70 and the redistribution of weight to the fruit harvester's hips from the fruit harvester's shoulders and back. The fruit harvester's support belt 10 generally comprises a belt portion 20 and a fastener 30, which fastener 30 connects to a distal end and a proximal end of the belt portion 20. The fruit harvester's support belt also generally comprises a front support 60, which may be attached to the interior side of the belt portion 20. The fruit harvester's support belt also generally comprises a receptacle support member 40, which may be attached to the upper edge of the belt portion 20. The fruit harvester's support belt also generally comprises a back support 50, which, in embodiments of the invention, is configured to slide onto the belt portion 20.

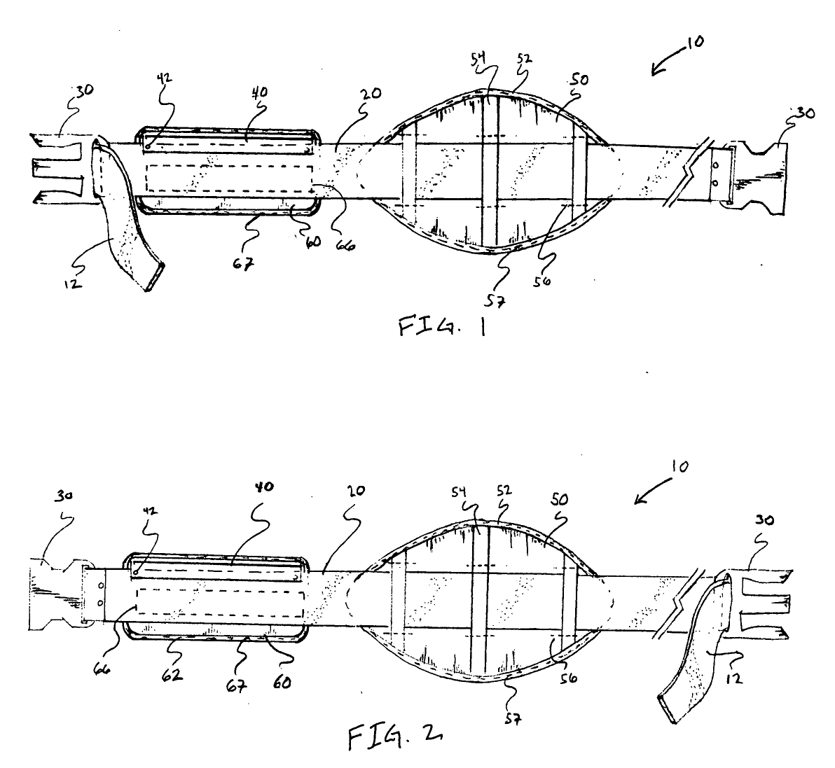

FIGS. 1 and 2 of the drawings disclose further details of the present invention. The fastener 30 connects to itself, and can be engaged easily by the user, and may be disengaged easily with one hand; however, the present invention is not limited to this particular type of fastener, as alternative types of fasteners may be used. The fastener 30 also allows for the belt portion 20 to be pulled through, which allows the user to shorten and lengthen the length of the belt portion 20 surrounding the user. FIG. 1 of the drawings discloses an embodiment of the present invention wherein the fastener 30 is situated so as to allow the user to tighten the fruit harvester's support belt by pulling the excess belt portion 12 towards the front of the user. This technique for adjusting the length of the belt portion 20 may be preferable as it is easier for the user to adjust the belt portion 20 by pulling the excess belt portion 12 forward than it is for the user to pull the excess belt portion 12 rearward. Nevertheless, as shown in FIG. 2, embodiments of the invention are also directed to a configuration in which there may be situations when it is preferable for the user to adjust the belt portion 20 by pulling the excess belt portion 12 rearward.

The receptacle support member 40 overlaps the upper edge of the belt portion 20 to provide a support for a receptacle. In embodiments of the invention, the receptacle support member 40 overlaps about 50% of the upper edge of the belt portion 20. In the one embodiment, the receptacle support member 40 is attached with rivets 42 to the upper edge of the belt portion 20. However, the present invention is not limited to using rivets to attach the receptacle support member, as any other method of securely attaching the receptacle support member 40 to the belt portion 20 may be used. The receptacle support member 40 lends itself to construction from a variety of materials, such as nylon.

The back support 50 slides over the belt portion 20, and comprises loops 54 that are attached to the back support edging 52 and the back side of the back support 50. The back support 50 is circumscribed by the back support edging 52 and are sewn together with stitches 57. The loops 54 are also attached with stitches 56, which stitches 56 are placed across the loops 54 on either side of the belt portion 20.

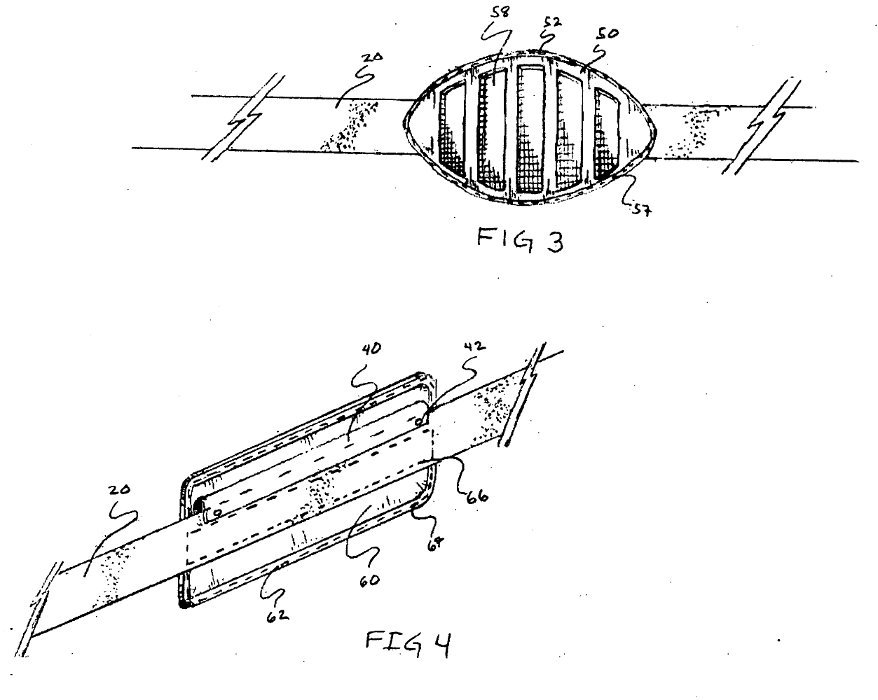

FIG. 3 shows a view of the interior of the back support 50, which back support 50 has pads 58 sewn into the interior side of the back support 50 for supplying further support and comfort for the wearer. The back support 50 lends itself to construction from a variety of materials, such as, e.g., molded foam and synthetic materials like nylon fabric work well for the back support 50. The back support edging 52 may also be constructed from a variety of materials, and nylon works well for the back support edging 52. Likewise, the loops 54 lend themselves to construction from a variety of materials as well, including synthetic materials like polypropylene.

In FIG. 4 of the drawings, the belt portion 20 is sewn to the front support 60 with stitching 66, which front support 60 is circumscribed by front support edging 62 and sewn together with stitching 67. The front support 60 lends itself to construction from a variety of materials, and synthetic materials like nylon fabric work well for the front support 60. The front support edging 62 may also be constructed from a variety of materials, such as nylon. FIG. 4 also shows another view of the receptacle support member 40 as it may be attached to the belt portion 20 with rivets 42.

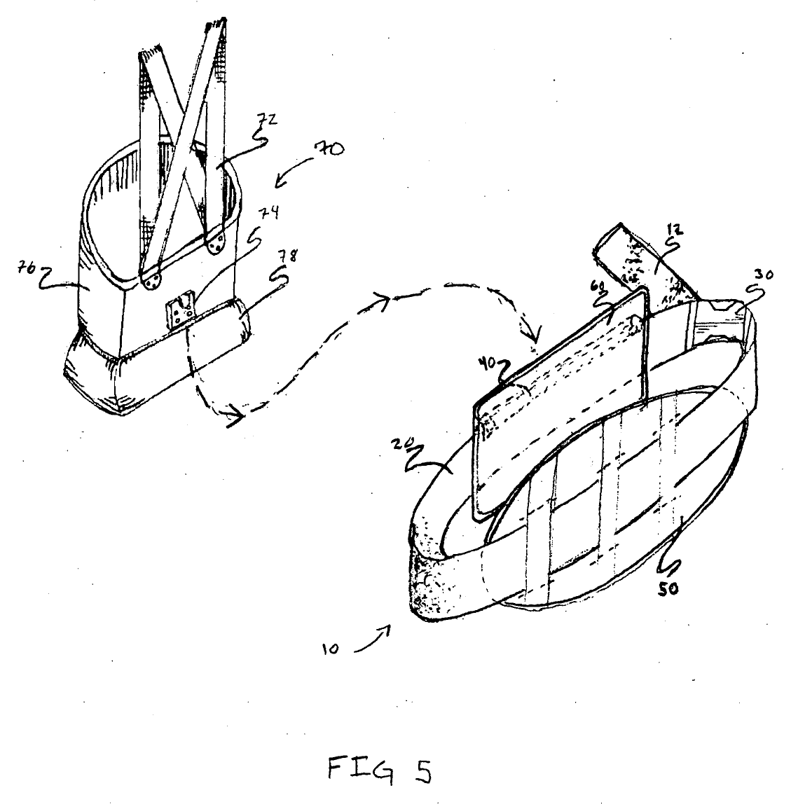

As shown in FIG. 5, the harvest bucket 70 comprises generally a receptacle portion 76 with an open top and an open bottom, which receptacle portion 76 may be connected to receptacle support straps 72 at the top edge of the receptacle portion 76. The harvest bucket 70 further comprises generally a closeable chute 78, which surrounds the bottom portion of the receptacle portion 76. The harvest bucket 70 further comprises generally a hook 74, which connects to a back side of the receptacle portion 76. The harvester support belt 10 connects to the receptacle portion 76 by attaching the hook 74 onto the top of the receptacle support member 40. The receptacle portion 76 lends itself to construction from a variety of materials, such as plastics, metals, canvas, etc. The closeable chute 78 may have, e.g., a drawstring for closing and opening. The closeable chute 78 lends itself to construction from a variety of materials, such as canvas. The hook 74 may be made from a variety of rigid materials, such as metal, which is inexpensive and abundant. The receptacle support straps 72 may be two parallel straps, i.e., they don't need to be criss-crossed. The receptacle support straps 72 may be made from a variety of materials, including synthetic materials such as nylon fabric.

In practice, a fruit harvest worker wears the harvest bucket 70 by placing his or her arms through the receptacle support straps 72, with the receptacle support straps 72 hanging from the worker's shoulders, and the receptacle portion 76 hanging by the receptacle support straps 72 in front of the worker. The worker wraps the harvester support belt 10 around his or her hips, with the back support 50 positioned at the worker's back, and with the front support 60 positioned in front of the worker. The worker then attaches the two ends of the fastener 30 to secure the harvester support belt 10. To adjust the tightness of the support belt 10, the worker pulls the excess belt portion 12 until the support belt 10 is the desired tightness. The worker engages the hook 74 with the receptacle support member 40 on the front of the front portion 60. With the hook 74 engaged with the receptacle support member 40, the system is ready for the worker to begin placing fruit into the receptacle portion 76. Thereby, the harvest bucket 70 is latched onto the harvester support belt 10, and the weight of the harvest bucket 70 as it is filled is then transferred away from the receptacle support straps 72 to the harvester support belt 10. As the weight of the harvest bucket 70 increases from the accumulation of fruit, the weight is redistributed to the hips of the worker away from the worker's back. When the bucket 70 is full, the chute is opened and the contents of the bucket 70 are emptied from the bucket 70. It is to be understood that the present invention is not limited to the embodiments described above, but encompasses any and all embodiments within the scope of the following claims.

What is claimed is:

1. A harvesting belt system, comprising:
a belt having a distal end and a proximal end, and a fastener affixed thereto, wherein the fastener is configured to releasably connect the proximal end to the distal end, thereby circumscribing a user's body;
a receptacle support member covering an upper edge of the belt;
a back support slidably surrounding a back portion of the belt; and
a front support attached to an interior front portion of the belt.

2. The system according to claim 1, wherein the belt is adjustable in length.

3. The system according to claim 2, wherein the belt is adjustable from a front side of the user.

4. The system according to claim 1, wherein the belt is made of a neoprene fabric.

5. The system according to claim 1, wherein the back support is padded.

6. The system according to claim 1 wherein the receptacle support member is made of nylon.

7. The system according to claim 1, wherein the receptacle support member is adapted to receive at least one connector coupled to a receptacle.

8. The system according to claim 7, wherein the at least one connector is configured to releasably connect the receptacle to the receptacle support member.

9. The system according to claim 7, wherein said at least one connector is a metal hook.

10. The system according to claim 7, wherein the receptacle is made of plastic.

11. The system according to claim 7, wherein the receptacle is made of metal.

12. The system according to claim 7, wherein the receptacle is made of canvas.

13. The system according to claim 7, further including at least one strap configured to be connected to the receptacle and worn on the user's body.

14. The system according to claim 1, wherein the receptacle support member is an extrusion.

15. The system according to claim 1, wherein the receptacle support member covers substantially the front portion of the belt's upper edge.
